(19) United States
(12) Patent Application Publication
(10) Pub. No.: US 2020/0169365 A1
(43) Pub. Date: May 28, 2020

(54) TRANSMISSION AND RECEPTION POINT (TRP) AND METHOD OF CHANNEL STATE INFORMATION-REFERENCE SIGNAL (CSI-RS) TRANSMISSION

(71) Applicant: NTT DOCOMO, INC., Tokyo (JP)

(72) Inventors: Yuichi Kakishima, Tokyo (JP); Chongning Na, Tokyo (JP); Satoshi Nagata, Tokyo (JP)

(73) Assignee: NTT DOCOMO, INC., Tokyo (JP)

(21) Appl. No.: 16/610,725

(22) PCT Filed: May 3, 2018
(86) PCT No.: PCT/US2018/030806

§ 371 Date: Nov. 4, 2019

Related U.S. Application Data
(60) Provisional application No. 62/501,296, filed on May 4, 2017.

(51) Int. Cl. H04L 5/00; H04B 7/06; H04L 27/26

(52) U.S. Cl. CPC H04L 5/0048; H04L 5/0023; H04L 27/2613; H04L 5/0007; H04B 7/0626

(57) ABSTRACT

A transmission and reception point (TRP) includes a processor that multiplexes multiple Channel State Information-Reference Signals (CSI-RSs) and at least one Cyclic Prefix (CP) within an Orthogonal Frequency-Division Multiplexing (OFDM) symbol. The TRP further includes a transmitter that transmits the multiple CSI-RSs and the at least one CP to a user equipment (UE). The at least one CP has a predetermined length.

### TECHNICAL FIELD

One or more embodiments disclosed herein relate to a transmission and reception point (TRP) and a method of Channel State Information-Reference Signals (CSI-RS s) transmission.

### BACKGROUND

For New Radio (NR) using higher frequencies, a hybrid (analogue/digital) beamforming system that performs beamforming using digital and analogue circuits may be introduced. In the hybrid beamforming system, an analogue beamforming unit is not able to switch a beam in each subband; therefore, multiplexing more beams per unit time may be important considering beam sweeping.

Accordingly, in the Third Generation Partnership Project (3GPP), a short Channel State Information-Reference Signal that multiplexes more beams per unit time is being studied. A time unit divided in an Orthogonal Frequency-Division Multiplexing (OFDM) symbol may be referred to as a “sub-time unit.” There are Interleaved Frequency-Division Multiple Access (IFDMA) and Larger Sub-Carrier Spacing (LSCS) schemes for the short CSI-RS as candidate schemes.

As shown in FIG. 1, the IFDMA is a method to acquire repeated signals in a time domain by multiplexing the CSI-RSs on part of subcarriers periodically. In FIG. 1, “K” indicates a frequency interval (sampling factor) in which the CSI-RSs are multiplexed. “N” indicates the number of resources of generated short CSI-RSs. In the IFDMA, in general, “K” is the same value as “N.”

As shown in FIG. 2, the LSCS is a method to shorten signals in a time domain to which the CSI-RSs is assigned by broaden a bandwidth of a subcarrier. In the LSCS, different precoders may be applied to multiple short CSI-RSs. In FIG. 2, a broaden bandwidth of the subcarrier that multiplexes the CSI-RSs is “K” times of a bandwidth of the subcarrier. “N” indicates the number of resources of generated short CSI-RSs. In the LSCS, in general, “K” is the same value as “N.”

In the IFDMA and the LSCS, multiple CSI-RSs can be transmitted by dividing the OFDM symbol into multiple sub-time units. Thus, in the IFDMA and the LSCS, the multiple CSI-RS resources can be multiplexed on the OFDM symbol; however, it is not possible to increase a Cyclic Prefix (CP) field. For example, in the IFDMA as shown in FIG. 1, the CP is multiplexed for the first CSI-RS; however, the CP is not multiplexed for the second and following CSI-RSs. For example, in the LSCS as shown in FIG. 2, the CP length is divided into four. Thus, the CP length in the LSCS is shorter than (a quarter of) a length of a CP multiplexed on other signals such as a CSI-RS for normal time unit and Physical Downlink Shared Channel (PDSCH). As a result, because the CP length is not sufficiently secured, it may be easily affected by a delay spread of a transmission channel.

### CITATION LIST

Non-Patent Reference

Non-Patent Reference 1: 3GPP, TS 36.211 V 14.2.0

Non-Patent Reference 2: R1-1702329; 3GPP TSG RAN WG1 Meeting #88; Athens, Greece, 13-17 Feb. 2017

### SUMMARY

One or more embodiments of the present invention relate to a transmission and reception point (TRP) that includes a processor that multiplexes multiple Channel State Information-Reference Signals (CSI-RSs) and at least one Cyclic Prefix (CP) within an Orthogonal Frequency-Division Multiplexing (OFDM) symbol. The TRP further includes a transmitter that transmits the multiple CSI-RSs and the at least one CP to a user equipment (UE). The at least one CP has a predetermined length.

One or more embodiments of the present invention relate to a method of CSI-RSs transmission in a wireless communication system. The method includes multiplexing, with a TRP, multiple CSI-RSs and at least one CP within an OFDM symbol, and transmitting, from the TRP to a UE, the multiple CSI-RSs and the at least one CP. The at least one CP has a predetermined length.

One or more embodiments of the present invention can secure sufficient Cyclic Prefixes in short CSI-RS transmission.

Other embodiments and advantages of the present invention will be recognized from the description and figures.

### BRIEF DESCRIPTION OF THE DRAWINGS

FIG. 1 is a diagram showing a method of Interleaved Frequency-Division Multiple Access (IFDMA) in conventional technologies.

FIG. 2 is a diagram showing a method of Larger Sub-Carrier Spacing (LSCS) in conventional technologies.

FIG. 3 is a diagram showing a configuration of a wireless communication system according to one or more embodiments of the present invention.

FIG. 4 is a sequence diagram showing an operation example of a CSI acquisition operation according to one or more embodiments of the present invention.

FIG. 5 is a diagram showing a conventional configuration of a CSI-RS and a CP in a OFDM symbol according to one or more embodiments of the present invention.

FIG. 6 is a diagram showing a configuration of short CSI-RSs and a CP in a OFDM symbol according to one or more embodiments of a first example of the present invention.

FIG. 7 is a diagram showing a configuration of short CSI-RSs and CPs in a OFDM symbol according to one or more embodiments of a second example of the present invention.

FIG. 8 is a diagram showing a configuration of short CSI-RSs and CPs in a OFDM symbol according to one or more embodiments of a third example of the present invention.

FIG. 9 is a diagram showing a configuration of short CSI-RSs and CPs in a OFDM symbol according to one or more embodiments of a fourth example of the present invention.

FIG. 10 is a diagram showing a configuration of short CSI-RSs and CPs in a OFDM symbol according to one or more embodiments of a fifth example of the present invention.

FIGS. 11A-11C are diagrams showing configurations of short CSI-RSs, CPs, and a guard interval in a OFDM symbol according to one or more embodiments of a sixth example of the present invention.

FIG. 12 is a diagram showing an example of a first configuration of a transmitter according to one or more embodiments of the present invention.

FIG. 13 is a diagram showing an example of a second configuration of a transmitter according to one or more embodiments of the present invention.

FIG. 14 is a diagram showing an example of a configuration of a receiver according to one or more embodiments of the present invention.

FIG. 15 is a diagram showing a schematic configuration of the TRP according to one or more embodiments of the present invention.

FIG. 16 is a diagram showing a schematic configuration of the UE according to one or more embodiments of the present invention.

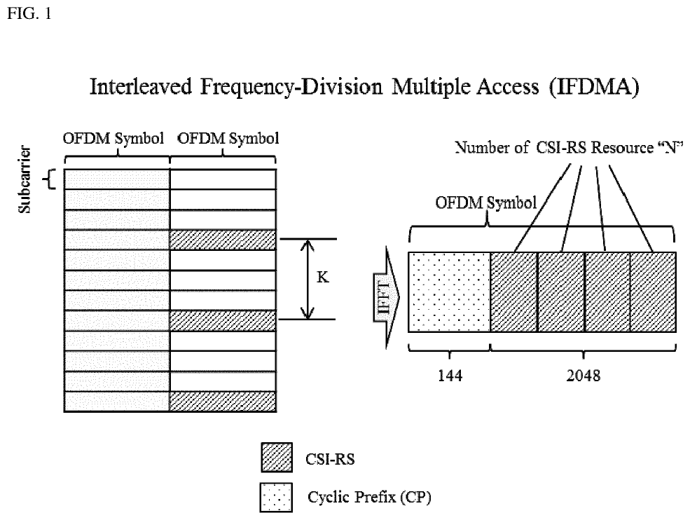

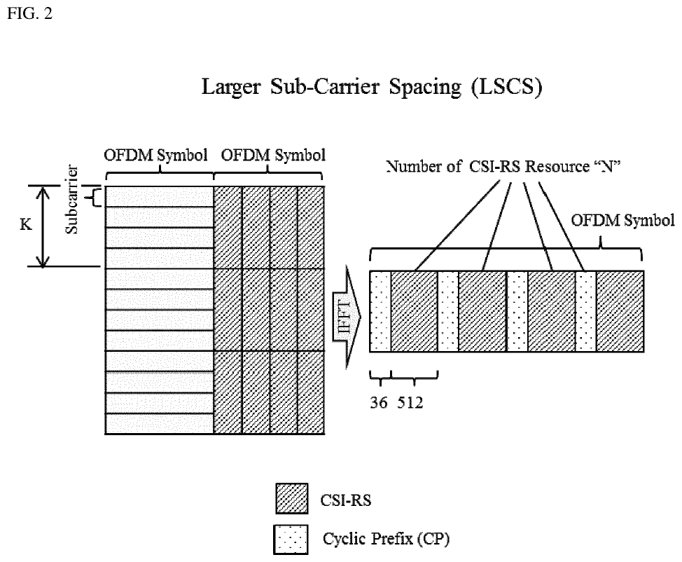

### DETAILED DESCRIPTION

Embodiments of the present invention will be described in detail below, with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

In one or more embodiments of the present invention, in IFDMA, “K” represents a frequency interval (sampling factor) in which CSI-RSs are multiplexed. “N” represents the number of resources of generated short CSI-RSs. In the IFDMA, “K” may be the same value as “N.”

In one or more embodiments of the present invention, in the LSCS, a broaden bandwidth of a subcarrier that multiplexes the CSI-RSs is “K” times of a bandwidth of a subcarrier. “N” indicates the number of resources of generated short CSI-RSs. In the LSCS, “K” may be the same value as “N.”

In one or more embodiments of the present invention, “L_{CP}” represents a conventional CP length of the OFDM symbol, which is not a short OFDM symbol. L_{CP} supported by the legacy LTE standards is 144, 160, 512, and 1024 point. Specifically, for the system with normal CP length, L_{CP} in OFDM symbol 1 to 6 is 144 and L_{CP} in OFDM symbol 0 is 160.

In one or more embodiments of the present invention, “L_{S}” represents a signal length of the conventional OFDM symbol (OFDM symbol length), which does not include the CP length. That is, L_{S} is a length of a normal CSI-RS (normal CSI-RS length). L_{S} supported by the legacy LTE standards is 2048 and 4096 points. In one or more embodiments of the present invention, a length of short CSI-RS (short CSI-RS length) is shorter than normal CSI-RS length.

In one or more embodiments of the present invention, “L_{SF}” represents a subframe (slot) length. L_{SF} supported by the legacy LTE standards is 15360 and 30720 points.

In one or more embodiments of the present invention, the conventional CSI-RS is indicated as a normal CSI-RS.

In one or more embodiments of the present invention, the signal length in a time domain may be indicated as “144,” “160,” . . . , but the signal length may be normalized. For example, in the LTE standard, a unit time length may be indicated as time slot “Ts” second. That is, in one or more embodiments of the present invention, values of the signal lengths may be indicated by multiplying the values by a factor such as “Ts”.

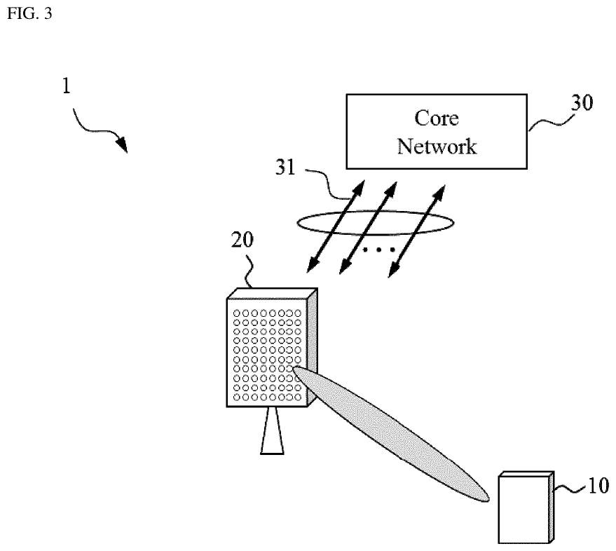

FIG. 3 is a wireless communications system 1 according to one or more embodiments of the present invention. The wireless communication system 1 includes a user equipment (UE) 10, a transmission and reception point (TRP) 20, and a core network 30. The wireless communication system 1 may be a New Radio (NR) system. The wireless communication system 1 is not limited to the specific configurations described herein and may be any type of wireless communication system such as an LTE/LTE-Advanced (LTE-A) system.

The TRP 20 may communicate uplink (UL) and downlink (DL) signals with the UE 10 in a cell of the TRP 20. The DL and UL signals may include control information and user data. The TRP 20 may communicate DL and UL signals with the core network 30 through backhaul links 31. The TRP 20 may be referred to as a base station (BS). The TRP 20 may be gNodeB (gNB).

The TRP 20 includes antennas, a communication interface to communicate with an adjacent TRP 20 (for example, X2 interface), a communication interface to communicate with the core network 30 (for example, S1 interface), and a CPU (Central Processing Unit) such as a processor or a circuit to process transmitted and received signals with the UE 10. Operations of the TRP 20 may be implemented by the processor processing or executing data and programs stored in a memory. However, the TRP 20 is not limited to the hardware configuration set forth above and may be realized by other appropriate hardware configurations as understood by those of ordinary skill in the art. Numerous TRPs 20 may be disposed so as to cover a broader service area of the wireless communication system 1.

The UE 10 may communicate DL and UL signals that include control information and user data with the TRP 20 using Multi Input Multi Output (MIMO) technology. The UE 10 may be a mobile station, a smartphone, a cellular phone, a tablet, a mobile router, or information processing apparatus having a radio communication function such as a wearable device. The wireless communication system 1 may include one or more UEs 10.

The UE 10 includes a CPU such as a processor, a RAM (Random Access Memory), a flash memory, and a radio communication device to transmit/receive radio signals to/from the TRP 20 and the UE 10. For example, operations of the UE 10 described below may be implemented by the CPU processing or executing data and programs stored in a memory. However, the UE 10 is not limited to the hardware configuration set forth above and may be configured with, e.g., a circuit to achieve the processing described below.

FIG. 4 is a sequence diagram showing an operation example of the beam management operation according to one or more embodiments of the present invention.

As shown in FIG. 4, at step S101, the TRP 20 may generate short CSI-RS. A configuration of the OFDM symbol including the CSI-RSs and the CP(s) will be described below in detail. At step S102, the TRP 20 may transmit the multiple CSI-RSs using TRP Tx beams, respectively, by beam sweeping.

The UE 10 may receive the CSI-RSs from the TRP 20. At step S103, the UE 10 may transmit feedback information to the TRP 20. For example, the feedback information may include at least one of Rank Indicator (RI), CSI-RS resource indicator (CRI), Precoding Matrix Indicator (PMI), Channel Quality Indicator (CQI), and Reference Signal Received Power (RSRP). Furthermore, the feedback information may include TRP Tx beam selected by the UE 10 (e.g., CSI-RS Resource Indicator (CRI)), UE Rx beam applied in the UE 10 (e.g., Sounding Reference Signal (SRS) Resource Indicator (SRI)), and beam reception quality (e.g., CSI, Reference Signal Received Power (RSRP), and Received Signal Strength Indicator (RSSI)).

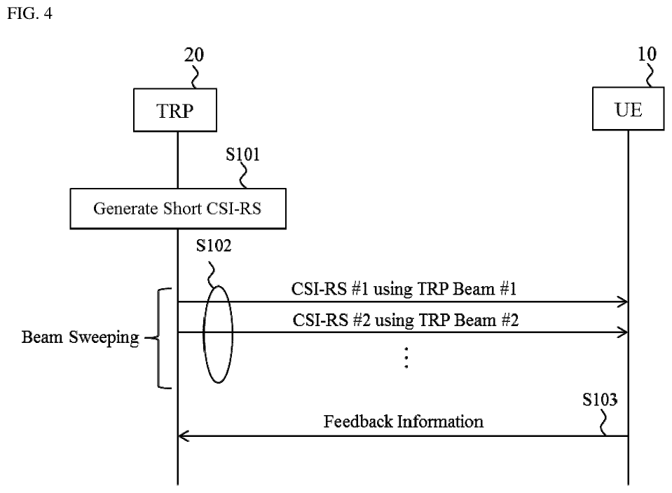

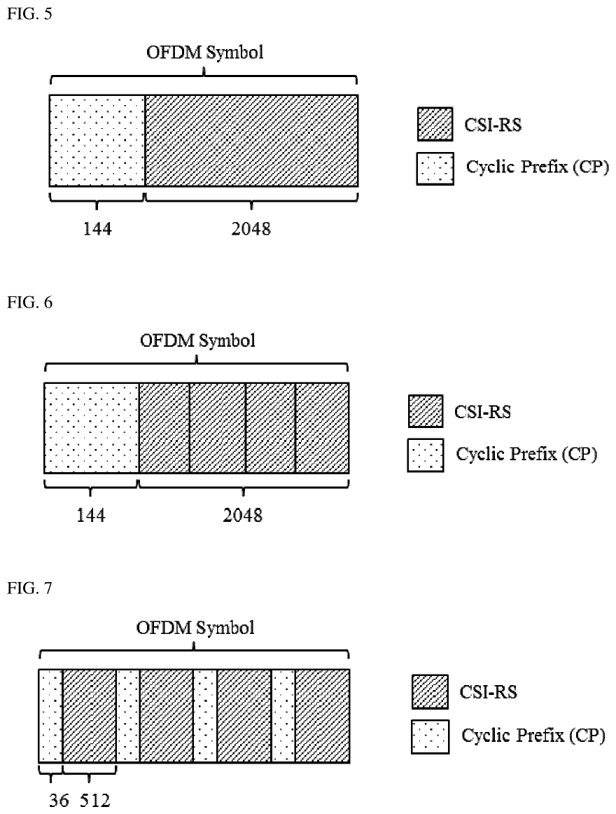

A configuration of the CSI-RSs (short CSI-RSs) and the CP(s) in the OFDM symbol according to one or more embodiments of the present invention will be described below, with reference to FIGS. 6-11. FIG. 5 is a diagram showing a conventional configuration of the CSI-RS and the CP in the OFDM symbol. As shown in FIG. 5, in the conventional configuration, the normal CSI-RS length (L_{S}) is 2048 and the CP length (L_{CP}) is 144 for one example case. In one or more embodiments of the present invention, for example, a bandwidth of a subcarrier may be 15 kHz.

### First Example

According to one or more embodiments of a first example of the present invention, when the short CSI-RSs are multiplexed in the OFDM symbol, the CP may be multiplexed on only a head of the OFDM symbol. As shown in FIG. 6, for example, the CP length of the short CSI-RSs may be the CP length (L_{CP} (e.g., 144)) of the normal CSI-RS.

In one or more embodiments of the first example of the present invention, the short CSI-RS length may be L_{S}/K. For example, as shown in FIG. 6, when K is 4, the short CSI-RS length is 2048/4, that is, 512. For example, K may be the same value of N. Thus, the short CSI-RS length may be a normal CSI-RS length divided by a predetermined value. The predetermined value is a frequency interval in which the short CSI-RSs are multiplexed within the OFDM symbol.

According to one or more embodiments of the first example of the present invention, the sufficient CP in short CSI-RS transmission can be secured.

### Second Example

According to one or more embodiments of a second example of the present invention, when the short CSI-RSs are multiplexed in the OFDM symbol, each of CPs may be multiplexed in the OFDM symbol for each short CSI-RS. Thus, the CP may be added to each of the short CSI-RSs. In other words, the number of CPs is the same as the number of short CSI-RSs. For example, the CP length applied to the short CSI-RS may be L_{CP}/N (or L_{CP}/K). In FIG. 7, the CP length of the short CSI-RS is 144/4, that is, 36.

For example, the CP length applied to the short CSI-RS is a conventional CP length divided by the number of multiple CSI-RSs.

For example, the short CSI-RS length may be a normal CSI-RS length divided by a predetermined value. The predetermined value is a frequency interval in which the short CSI-RSs are multiplexed within the OFDM.

In one or more embodiments of the second example of the present invention, the short CSI-RS length may be L_{S}/K. For example, as shown in FIG. 7, when K is 4, the short CSI-RS length is 2048/4, that is, 512. For example, K may be the same value of N.

According to one or more embodiments of the second example of the present invention, the sufficient CPs in short CSI-RS transmission can be secured.

### Third Example

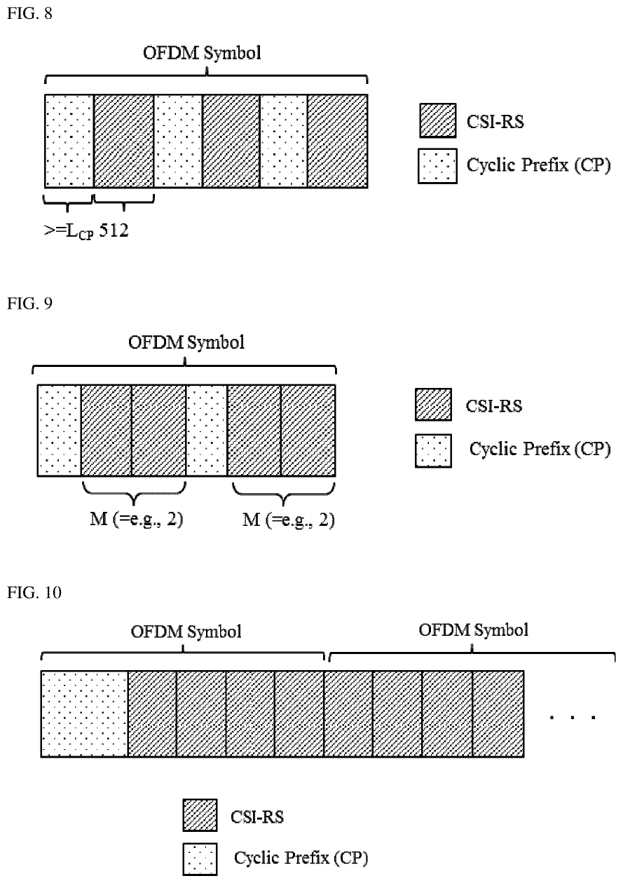

According to one or more embodiments of a third example of the present invention, when the short CSI-RSs are multiplexed in the OFDM symbol, K is greater than N (K>N) (e.g., K=4, N=3). As shown in FIG. 8, the short CSI-RS length may be L_{S}/K. For example, in FIG. 8, the short CSI-RS length is 2048/4, that is, 512. In one or more embodiments of the third example of the present invention, the CP of the short CSI-RS may be longer that may be greater than or equal to L_{CP} (or L_{CP}/N, L_{CP}/K). According to one or more embodiments of a third example of the present invention, the more sufficient CP length may be secured because K is greater than N. According to one or more embodiments of the third example of the present invention, the sufficient CPs in short CSI-RS transmission can be secured.

Thus, when the short CSI-RSs and the multiple CPs applied to the short CSI-RSs are multiplexed within the OFDM symbol, a predetermined value is greater than a number of the multiple CSI-RSs. The predetermined value is a frequency interval in which the multiple CSI-RSs are multiplexed within the OFDM symbol. For example, a short CSI-RS length may be a normal CSI-RS length divided by the predetermined value. As another example, the predetermined length is greater than a conventional CP length.

### Fourth Example

According to one or more embodiments of a fourth example of the present invention, when the short CSI-RSs are multiplexed in the OFDM symbol, the CP(s) may be multiplexed for only part of the short CSI-RSs in the OFDM symbol. The existence of CP information can be informed to UE. For example, the CP may be multiplexed for each group of “M” short CSI-RSs. FIG. 9 shows an example of the configuration of the short CSI-RSs and the CPs where M is 2. In FIG. 9, the CP is added to the two short CSI-RSs. The configuration according to one or more embodiments of the fourth example of the present invention may be effective when transmission beams are switched in each group of two short CSI-RSs. Thus, the number of the CPs may be less than the number of the short CSI-RSs.

### Fifth Example

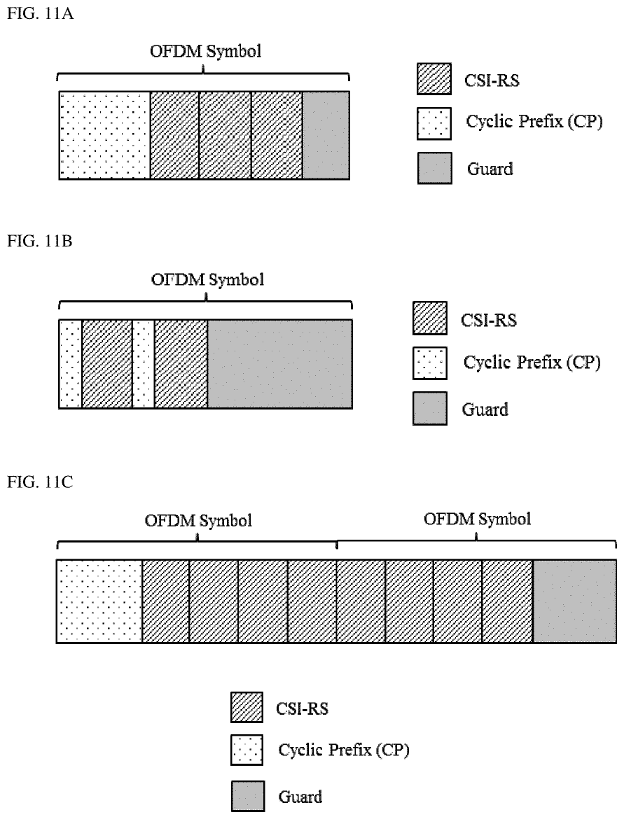

According to one or more embodiments of a fifth example of the present invention, when the short CSI-RSs are multiplexed in the OFDM symbol, the CP may not be multiplexed on a head of the OFDM symbol. As shown in FIG. 10, when the multiple short CSI-RSs in the successive OFDM symbols are the same, the CP may not be added to the head of the following OFDM symbol. When the same CSI-RS are transmitted repeatedly, it may not necessary to multiplex the CP on the OFDM symbol.

Thus, when another OFDM symbol follows the OFDM symbol in which the multiple short CSI-RSs are multiplexed, a CP is not multiplexed within another OFDM symbol. When multiple short CSI-RSs are multiplexed within the second OFDM symbol, each of the multiple short CSI-RSs within the OFDM symbol and another OFDM symbol is the same short CSI-RS.

In one or more embodiments of the first example of the present invention, the short CSI-RS length may be L_{S}/K. For example, as shown in FIG. 6, when K is 4, the short CSI-RS length is 2048/4, that is, 512. For example, K may be the same value of N.

### Sixth Example

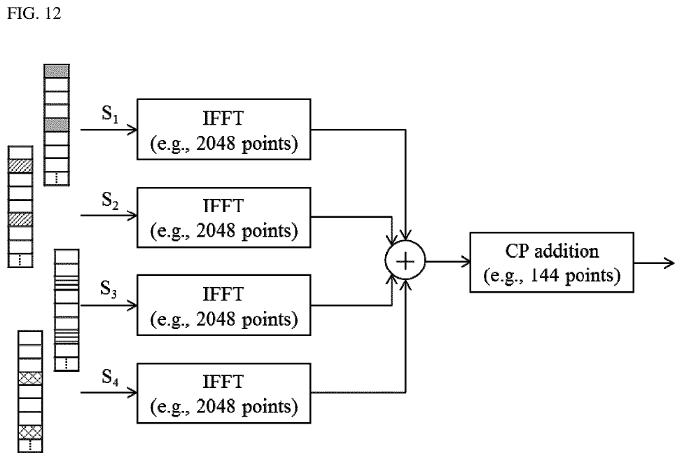

For example, when K is greater than N as in one or more embodiments of the third example of the present invention, a total length of the short CSI-RS length(s) and the CP length(s) may be less than a length of the OFDM symbol. According to one or more embodiments of a sixth example of the present invention, a gap between the length of the OFDM symbol and the total length of the short CSI-RS lengths and the CP length(s) may be set as a guard interval. For example, as shown in FIGS. 11A-11C, the guard interval may set in an end of the OFDM symbol. For example, the guard interval may set in a head of the OFDM symbol.

In one or more embodiments of the sixth example of the present invention, the signals may be muted in the guard interval. As another example, the CP may be added in the guard interval.

### Seventh Example

According to one or more embodiments of an eighth example of the present invention, frequency-multiplexing may be applied to the IFDMA and multiple beams (multiple resources) can be transmitted. The maximum number of beams may be “K”.

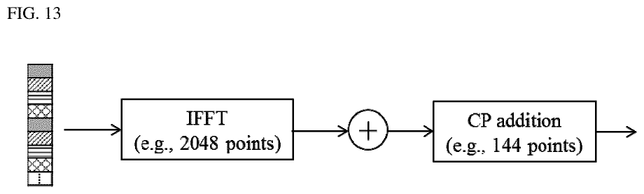

For example, according to one or more embodiments of the eighth example of the present invention, a transmitter may transmit multiple signals having different subcarrier offsets in the IFDMA simultaneously. For example, according to one or more embodiments of the eighth example of the present invention, the transmitter may transmit the number of the beams and the subcarrier offsets. FIGS. 12 and 13 show examples of first and second configurations of the transmitter, respectively, according to one or more embodiments of the present invention.

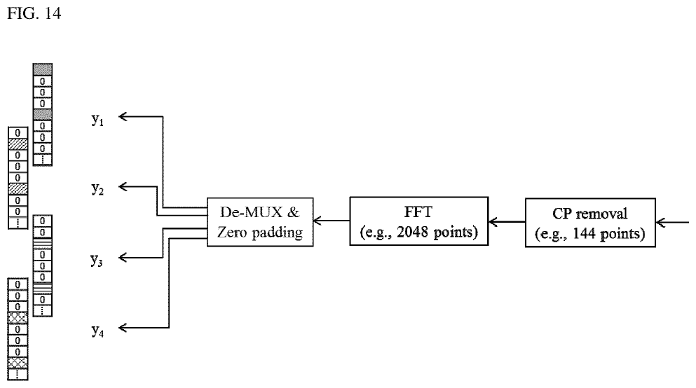

According to one or more embodiments of the eighth example of the present invention, at the receiver, de-multiplexing and zero-padding may be performed and the multiple beams may be separated in a frequency domain. The de-multiplexing may be processing to separate signals after Fast Fourier transform (FFT) processing. FIG. 14 shows an example of configurations of the receiver, according to one or more embodiments of the present invention.

### Eighth Example

The number of the CPs in the OFDM symbol, the number of the short CSI-RSs in the OFDM symbol, and the short CSI-RS length are represented as “N_{CP},” “N_{SRS},” and “L_{SRS},” respectively. According to one or more embodiments of an eighth example of the present invention, multiple CS lengths may be determined as follows.

For example, in one or more embodiments of the eighth example of the present invention, the second to N_{CP}-th CP lengths may be set to L_{CP} and the first CP length may be set to a length of the rest in the OFDM symbol. The second to N_{CP}-th CP lengths may be represented as “L_{CP}.” The first CP length may be represented as L_{SF}−N_{SRS}*L_{SRS}−L_{SCP}(N_{CP}−1).

For example, in one or more embodiments of the eighth example of the present invention, the first to (N_{CP}-1)-th CP lengths may be set to L_{CP} and the N_{CP}-th CP length may be set to a length of the rest in the OFDM symbol. The first to (N_{CP}-1)-th CP lengths may be represented as “L_{CP}.” The N_{CP}-th CP length may be represented as L_{SF}-N_{SRS}*L_{SRS}−L_{SCP}(N_{CP}−1).

For example, in one or more embodiments of the eighth example of the present invention, to moderate a sampling frequency of a receiver, the CP lengths may be equal to each other as possible. For example, one or more embodiments of the eighth example of the present invention may cause all of the short CSI-RSs to have maximum propagation delay resistance. For example, the second to N_{CP}-th CP lengths may be represented as └(L_{SF}−N_{SRS}L_{SRS})/N_{CP}┘. The first CP length may be represented as L_{SF}−N_{SRS}L_{SRS}−(N_{CP}−1)└(L_{SF}−N_{SRS}L_{SRS})/N_{CP}┘.

As another example to moderate a sampling frequency of a receiver, for example, the first to (N_{CP}−1)-th CP lengths may be represented as └L_{SF}−N_{SRS}L_{SRS})/N_{CP}┘ and the N_{CP}-th CP length may be represented as L_{SF}−N_{SRS}L_{SRS}−(N_{CP}1)└(L_{SF}−N_{SRS}L_{SRS})/N_{CP} ┘.

### Another Example

According to one or more embodiments of another example of the present invention, the TRP 20 may notify the UE 10 of information including the above “K,” “N,” and “M” using at least one of Master Information Block (MIB)/System Information Block (SIB), Radio Resource Control (RRC) signaling, Medium Access Control Control Element (MAC CE), and Downlink Control Information (DCI). In addition, for IFDMA, a frequency offset value can be informed to UE.

According to one or more embodiments of another example of the present invention, so that the multiple short CSI-RS lengths are the same, the number of the short CSI-RSs in one OFDM symbol may be limited to all or part of divisors of L_{S} (e.g., 1, 2, 4, 8, . . . ).

(Configuration of TRP)

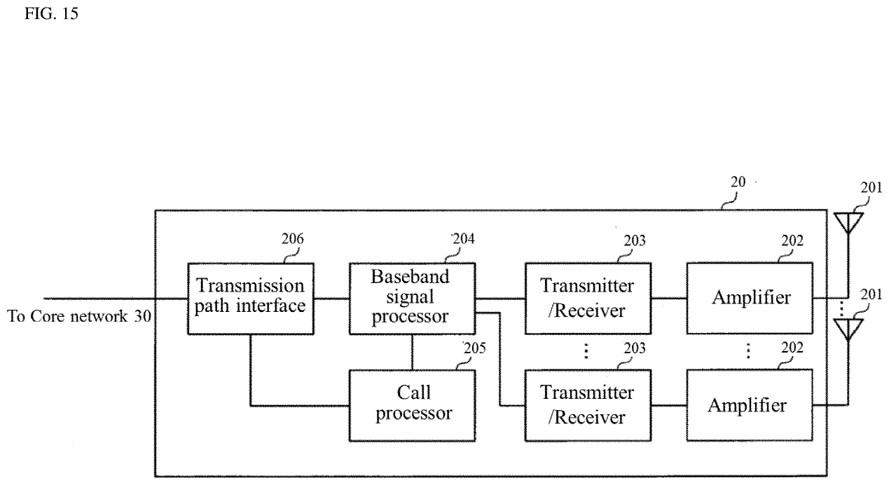

The TRP 20 according to one or more embodiments of the present invention will be described below with reference to FIG. 15. FIG. 15 is a diagram illustrating a schematic configuration of the TRP 20 according to one or more embodiments of the present invention. The TRP 20 may include a plurality of antennas (antenna element group) 201, amplifier 202, transceiver (transmitter/receiver) 203, a baseband signal processor 204, a call processor 205 and a transmission path interface 206.

User data that is transmitted on the DL from the TRP 20 to the UE 20 is input from the core network 30, through the transmission path interface 206, into the baseband signal processor 204.

In the baseband signal processor 204, signals are subjected to Packet Data Convergence Protocol (PDCP) layer processing, Radio Link Control (RLC) layer transmission processing such as division and coupling of user data and RLC retransmission control transmission processing, Medium Access Control (MAC) retransmission control, including, for example, HARQ transmission processing, scheduling, transport format selection, channel coding, inverse fast Fourier transform (IFFT) processing, and precoding processing. Then, the resultant signals are transferred to each transceiver 203. As for signals of the DL control channel, transmission processing is performed, including channel coding and inverse fast Fourier transform, and the resultant signals are transmitted to each transceiver 203.

The baseband signal processor 204 notifies each UE 10 of control information (system information) for communication in the cell by higher layer signaling (e.g., RRC signaling and broadcast channel). Information for communication in the cell includes, for example, UL or DL system bandwidth.

In each transceiver 203, baseband signals that are precoded per antenna and output from the baseband signal processor 204 are subjected to frequency conversion processing into a radio frequency band. The amplifier 202 amplifies the radio frequency signals having been subjected to frequency conversion, and the resultant signals are transmitted from the antennas 201.

As for data to be transmitted on the UL from the UE 10 to the TRP 20, radio frequency signals are received in each antennas 201, amplified in the amplifier 202, subjected to frequency conversion and converted into baseband signals in the transceiver 203, and are input to the baseband signal processor 204.

The baseband signal processor 204 performs FFT processing, IDFT processing, error correction decoding, MAC retransmission control reception processing, and RLC layer and PDCP layer reception processing on the user data included in the received baseband signals. Then, the resultant signals are transferred to the core network 30 through the transmission path interface 206. The call processor 205 performs call processing such as setting up and releasing a communication channel, manages the state of the TRP 20, and manages the radio resources.

(Configuration of UE)

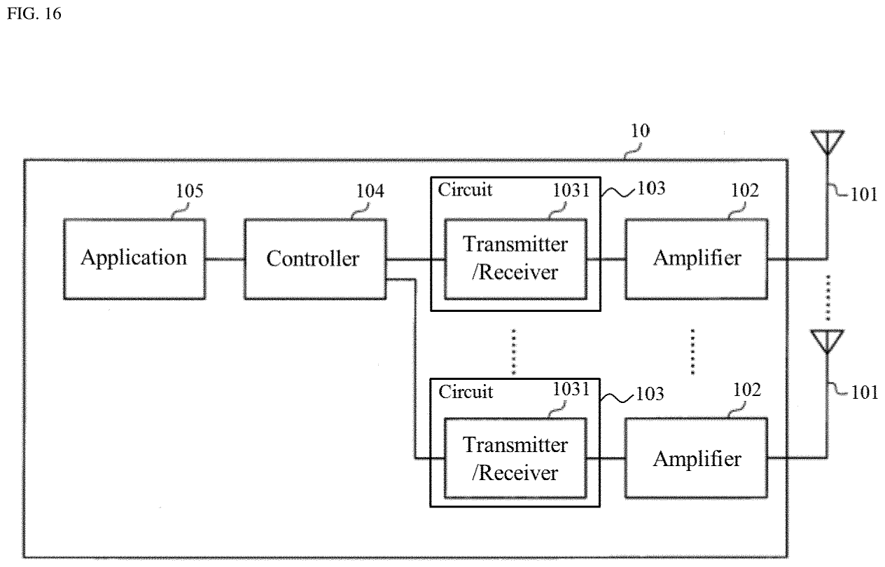

The UE 10 according to one or more embodiments of the present invention will be described below with reference to FIG. 16. FIG. 16 is a schematic configuration of the UE 10 according to one or more embodiments of the present invention. The UE 10 has a plurality of UE antennas 101, amplifiers 102, the circuit 103 comprising transceiver (transmitter/receiver) 1031, the controller 104, and an application 105.

As for DL, radio frequency signals received in the UE antennas 101 are amplified in the respective amplifiers 102, and subjected to frequency conversion into baseband signals in the transceiver 1031. These baseband signals are subjected to reception processing such as FFT processing, error correction decoding and retransmission control and so on, in the controller 104. The DL user data is transferred to the application 105. The application 105 performs processing related to higher layers above the physical layer and the MAC layer. In the downlink data, broadcast information is also transferred to the application 105.

On the other hand, UL user data is input from the application 105 to the controller 104. In the controller 104, retransmission control (Hybrid ARQ) transmission processing, channel coding, precoding, DFT processing, IFFT processing and so on are performed, and the resultant signals are transferred to each transceiver 1031. In the transceiver 1031, the baseband signals output from the controller 104 are converted into a radio frequency band. After that, the frequency-converted radio frequency signals are amplified in the amplifier 102, and then, transmitted from the antenna 101.

One or more embodiments of the present invention may be used for each of the uplink and the downlink independently. One or more embodiments of the present invention may be also used for both of the uplink and the downlink in common.

Although the present disclosure mainly described examples of a channel and signaling scheme based on NR, the present invention is not limited thereto. One or more embodiments of the present invention may apply to another channel and signaling scheme having the same functions as NR such as LTE/LTE-A and a newly defined channel and signaling scheme.

Although the present disclosure mainly described examples of technologies based on the CSI-RS, the present invention is not limited thereto. One or more embodiments of the present invention may apply to another synchronization signal, reference signal, and physical channel such as Primary Synchronization Signal/Secondary Synchronization Signal (PSS/SSS) and Sounding Reference Signal (SRS).

Although the present disclosure mainly described examples of the bandwidth of the subcarrier that is 15 kHz, one or more embodiments of the present invention may be applied to different bandwidths of the subcarrier other than 15 kHz. For example, predetermined parameters may be determined so that the predetermined parameters are in directly or inversely proportional to the bandwidth of the subcarrier, OFDM symbol length, and the CP length.

Although the present disclosure described examples of the normal CP length, one or more embodiments of the present invention may be applied to an Extended CP length.

Although the present disclosure mainly described examples of the IFDMA and the LSCS used to generate the short CSI-RSs, the present invention is not limited thereto. For example, in one or more embodiments of the present invention, Discrete Fourier Transform (DFT) may be used to generate the short CSI-RSs.

Although the present disclosure described examples of various signaling methods, the signaling according to one or more embodiments of the present invention may be explicitly or implicitly performed.

Although the present disclosure mainly described examples of various signaling methods, the signaling according to one or more embodiments of the present invention may be the higher layer signaling such as the RRC signaling and/or the lower layer signaling such as the DCI and the MAC CE. Furthermore, the signaling according to one or more embodiments of the present invention may use a Master Information Block (MIB) and/or a System Information Block (SIB). For example, at least two of the RRC, the DCI, and the MAC CE may be used in combination as the signaling according to one or more embodiments of the present invention.

According to one or more embodiments of the present invention, whether the physical signal/channel is beamformed may be transparent for the UE. The beamformed RS and the beamformed signal may be called the RS and the signal, respectively. Furthermore, the beamformed RS may be referred to as a RS resource. Furthermore, the beam selection may be referred to as resource selection. Furthermore, the Beam Index may be referred to as a resource index (indicator) or an antenna port index.

One or more embodiments of the present invention may apply to CSI measurement, channel sounding, beam management, and other beam control scheme such as beam management using the SS.

In one or more embodiments of the present invention, the RB and a subcarrier in the present disclosure may be replaced with each other. A subframe, a symbol, and a slot may be replaced with each other.

The above examples and modified examples may be combined with each other, and various features of these examples can be combined with each other in various combinations. The invention is not limited to the specific combinations disclosed herein.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A transmission and reception point (TRP) comprising:
a processor that multiplexes multiple Channel State Information-Reference Signals (CSI-RSs) and at least one Cyclic Prefix (CP) within an Orthogonal Frequency-Division Multiplexing (OFDM) symbol; and
a transmitter that transmits the multiple CSI-RSs and the at least one CP to a user equipment (UE),
wherein the at least one CP has a predetermined length.

2. The TRP according to claim 1, wherein the CP is multiplexed only at a head of the OFDM symbol.

3. The TRP according to claim 2, wherein the predetermined length is a coventional CP length.

4. The TRP according to claim 2,
wherein a CSI-RS length of each of the multiple CSI-RSs is a normal CSI-RS length divided by a predetermined value, and
wherein the predetermined value is a frequency interval in which the multiple CSI-RSs are multiplexed within the OFDM symbol.

5. The TRP according to claim 1,
wherein the processor multiplexes the multiple CSI-RSs and multiple CPs within the OFDM symbol, and
wherein a number of the multiple CPs is a same as a number of the multiple CSI-RSs.

6. The TRP according to claim 5, wherein the predetermined length is a conventional CP length divided by the number of multiple CSI-RSs.

7. The TRP according to claim 5,
wherein a CSI-RS length of each of the multiple CSI-RSs is a normal CSI-RS length divided by a predetermined value, and
wherein the predetermined value is a frequency interval in which the multiple CSI-RSs are multiplexed within the OFDM symbol.

8. The TRP according to claim 1,
wherein the processor multiplexes the multiple CSI-RSs and multiple CPs within the OFDM symbol,
wherein a predetermined value is greater than a number of the multiple CSI-RSs, and
wherein the predetermined value is a frequency interval in which the multiple CSI-RSs are multiplexed within the OFDM symbol.

9. The TRP according to claim 8, wherein a CSI-RS length of each of the multiple CSI-RSs is a normal CSI-RS length divided by the predetermined value.

10. The TRP according to claim 8, wherein the predetermined length is greater than a coventional CP length.

11. The TRP according to claim 1, wherein a number of the at least one CP is less than a number of the multiple CSI-RSs.

12. The TRP according to claim 1,
wherein when a second OFDM symbol follows the OFDM symbol in which the multiple CSI-RSs are multiplexed, a CP is not multiplexed within the second OFDM symbol,
wherein second multiple CSI-RSs are multiplexed within the second OFDM symbol, and
wherein each of the multiple CSI-RSs and the second multiple CSI-RSs is a same short CSI-RS.

13. A method of Channel State Information-Reference Signals (CSI-RSs) transmission in a wireless communication system, the method comprising:
multiplexing, with a transmission and reception point (TRP), multiple CSI-RSs and at least one Cyclic Prefix (CP) within an Orthogonal Frequency-Division Multiplexing (OFDM) symbol; and
transmitting, from the TRP to a user equipment (UE), the multiple CSI-RSs and the at least one CP,
wherein the at least one CP has a predetermined length.

14. The method according to claim 13, wherein the CP is multiplexed only at a head of the OFDM symbol.

15. The method according to claim 14, wherein the predetermined length is a conventional CP length.

16. The method according to claim 14,
wherein a CSI-RS length of each of the multiple CSI-RSs is a normal CSI-RS length divided by a predetermined value, and
wherein the predetermined value is a frequency interval in which the multiple CSI-RSs are multiplexed within the OFDM symbol.

17. The method according to claim 13,
wherein the multiplexing multiplexes the multiple CSI-RSs and multiple CPs within the OFDM symbol, and
wherein a number of the multiple CPs is a same as a number of the multiple CSI-RSs.

18. The method according to claim 17, wherein the predetermined length is a conventional CP length divided by the number of multiple CSI-RSs.

19. The method according to claim 17,
wherein a CSI-RS length of each of the multiple CSI-RSs is a normal CSI-RS length divided by a predetermined value, and
wherein the predetermined value is a frequency interval in which the multiple CSI-RSs are multiplexed within the OFDM symbol.

20. The method according to claim 13,
wherein the multiplexing multiplexes the multiple CSI-RSs and multiple CPs within the OFDM symbol,
wherein a predetermined value is greater than a number of the multiple CSI-RSs, and
wherein the predetermined value is a frequency interval in which the multiple CSI-RSs are multiplexed within the OFDM symbol.
